(19) United States
(12) Patent Application Publication
(10) Pub. No.: US 2010/0154750 A1
(43) Pub. Date: Jun. 24, 2010

(54) Method For Injecting Fuel With The Aid Of A Fuel-Injection System

(76) Inventors: Axel Storch, Moeglingen (DE); Corren Heimgaertner, Stuttgart (DE)

Correspondence Address: KENYON & KENYON LLP, ONE BROADWAY, NEW YORK, NY, 10004, US

(21) Appl. No.: 11/988,070

(22) PCT Filed: Jul. 17, 2006
(86) PCT No.: PCT/EP2006/064340

§ 371 Date: Mar. 11, 2010

(51) Int. Cl. F02M 51/00

(52) U.S. Cl. 123/490

(57) ABSTRACT

A fuel injection system (1) for the targeted injection of fuel, comprising a fuel injection valve (2) having a solenoid coil (3), which cooperates with an armature (5) supplied by a return spring (4), the armature forming an axially displaceable valve part together with a valve needle (6), and a control device (9). The control device (9) defines an opening phase (10) having a first holding current (12), and a closing phase (11) beginning after the opening phase (10) and having a second holding current (13) for the fuel injection valve (2), wherein the current characteristic in the solenoid coil (3) is defined during the closing phase (11) of the injection valve (2) such that the magnetic field generated by the second holding current (13) flowing through the solenoid coil (3) brings about a certain magnetic force, such that the valve needle (6) thus experiences a defined stroke (14) that is different from zero, and steadily maintains the same over a defined period of time.

### FIELD OF THE INVENTION

The present invention relates to a method and system for injecting fuel with the aid of a fuel-injection system.

### BACKGROUND INFORMATION

German Patent Application No. DE 198 55 547 A1 describes a fuel injector which has a core, a solenoid coil and an armature, which can be acted upon in a lift direction by the solenoid coil counter to a return spring, as well as a valve needle. The valve needle is fixedly connected both to the armature and a valve-closure member cooperating with a fixed sealing seat and forms a displaceable valve member. Situated on the valve needle between the armature and the valve-closure member is an auxiliary body, which is displaceable relative to the valve needle. The valve needle is equipped with an engaging piece such that, in response to a movement of the auxiliary body in the lift direction, the valve needle can be accelerated in the same direction, thereby allowing rapid opening of the fuel injector.

A particular disadvantage of this fuel injector is that, although the opening movement of the fuel injector can occur rapidly, the closing movement occurs linearly at a time delay. This has a disadvantageous effect on the throttling phase of the fuel injector and causes poor carburetion because of a fuel jet that has the form of a cone, the cone angle being small. A large cone angle of the emerging fuel jet is desirable for optimal carburetion, so that the divergence of the emerging fuel jet is able to fill the combustion chamber to best effect, which in turn ensures uniform and complete combustion of the fuel-air mixture in the combustion chamber of an internal combustion engine.

### SUMMARY

In contrast, a method for injecting fuel according to an example embodiment of the present invention, and an example fuel-injection system, which includes a fuel injector and a control device according to the present invention offer the advantage that the valve needle is stopped briefly during the closing operation, so that the gap which has formed between the valve seat and valve-closure member as a result of the lift of the valve needle remains constant for a certain period of time. This flow restriction of the fuel injector, which corresponds to an extension of the closing operation, has an advantageous effect on the cone angle of the jet in the vicinity of the nozzle at the nozzle exit, i.e., the cone angle of the jet in the vicinity of the nozzle is enlarged by the method according to the present invention. This results in better atomization of the widened fuel jet and thus in improved air detection, which increases the ignitability of the produced fuel-air mixture.

Another advantage of the present invention consists of an expansion of the spatial and chronological tolerance of the assignment of jet and ignition spark. This means that the actual ignition instant may occur both a small tolerance time in advance of and following the optimal, calculated ignition instant or an ignition instant determined in a simulation. Expanding the spatial tolerance means that even a thinner fuel-air mixture is able to be optimally ignited in the combustion chamber.

Furthermore, it is advantageous that the injected fuel is throttled in the valve seat of the nozzle. This effect is adjustable as a function of a lift of the valve needle and thus adaptable to different embodiments of fuel injectors.

It is also advantageous that the throttling of the fuel injector is able to be switched on and off with the aid of the control device provided for that purpose.

It is also advantageous that a double coil may be used instead of a single solenoid coil, which optionally may be activated or deactivated for the more rapid opening or closing of the fuel injector.

### BRIEF DESCRIPTION OF THE DRAWINGS

An exemplary embodiment of the present invention is represented in simplified form in the figures and is explained in greater detail below.

FIG. 1 shows a state-time diagram of an example method according to the present invention including an opening phase and a closing phase of a fuel injector.

FIG. 2 shows a current-time diagram of the current, as it is impressed upon the solenoid coil according to the example method of the present invention.

FIG. 3 shows a lift-time diagram of the valve needle according to the example method of the present invention.

FIG. 4 shows an injection quantity-time diagram of the example method according to the present invention.

FIG. 5 shows an example fuel-injection system according to the present invention, made up of a fuel injector and a control device for the selective injection of fuel.

FIG. 6 shows a possible spray-orifice geometry of the nozzle of the fuel injector.

FIG. 7 shows a detail VII of the fuel injector according to the present invention in FIG. 1, which illustrates the difference between an individual jet cone angle and an overall jet cone angle.

### DETAILED DESCRIPTION OF EXAMPLE EMBODIMENTS

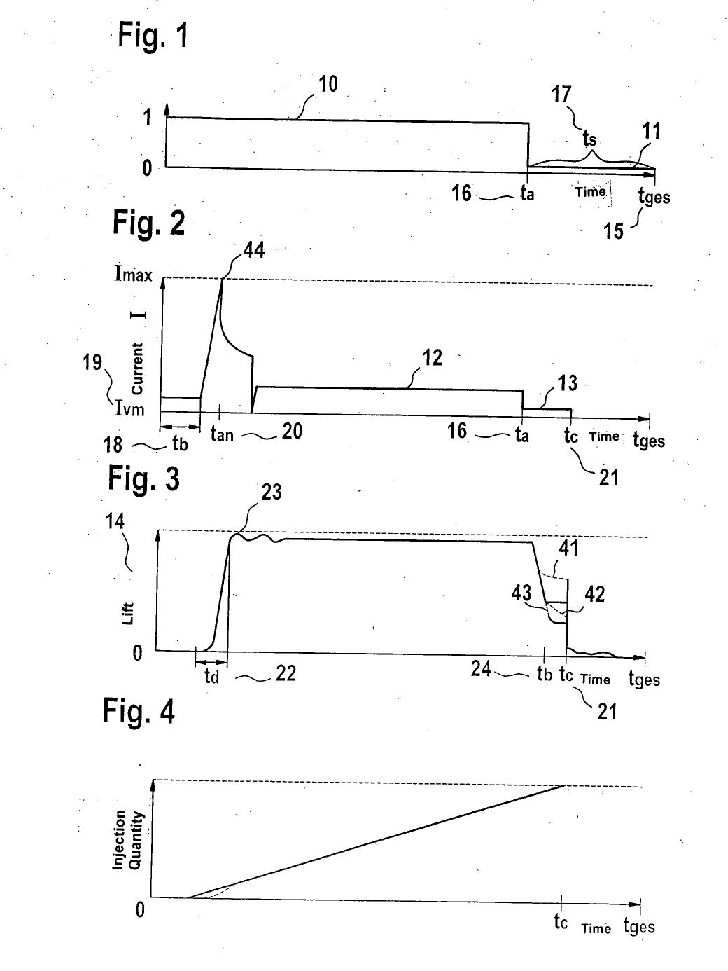

In the following text, an exemplary embodiment of the present invention will be described by way of example on the basis of FIGS. 1 through 7.

FIG. 1 shows a state-time diagram of an example method for the selective injection of fuel according to the present invention, with an opening phase 10 and a closing phase 11 of a fuel injector 2. In a first method step, a control device 9, which is part of an example fuel-injection system 1 according to the present invention, specifies that a total time interval t_{ges} 15 be provided for opening phase 10 and closing phase 11 of fuel injector 1. Within this time interval t_{ges} 15, which results from the addition of a time interval tₐ 16 and a time interval tₛ 17, an opening phase 10 is specified for fuel injector 2, which corresponds to time interval tₐ 16 and state “1” plotted on an ordinate of the state-time diagram, and a closing phase 11, which corresponds to time interval tₛ 17 and state “0” plotted on an abscissa of the state-time diagram.

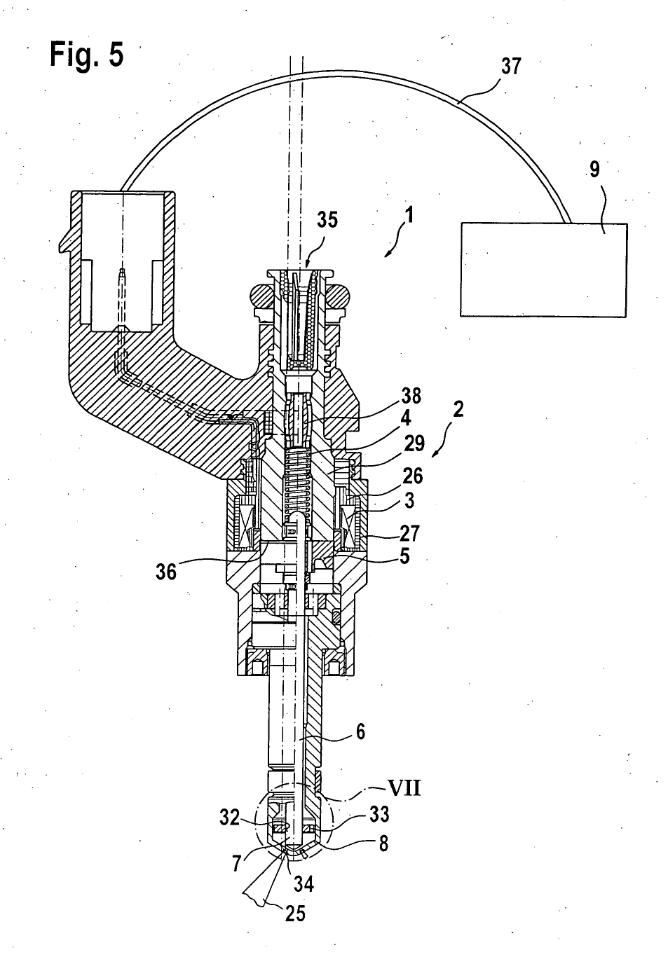

As shown in FIG. 5, the example method according to the present invention for the selective injection of fuel with the aid of a fuel-injection system 1 includes a fuel injector 2 having a solenoid coil 3, which cooperates with an armature 5 acted upon by a restoring spring 4, the armature forming an axially displaceable valve component together with a valve needle 6, and a control device 9 for controlling fuel injector 2. A valve-closure member 7, which forms a sealing seat together with a valve-seat body 8, is provided on valve needle 6. In a first method step, control device 9, which is connected to fuel injector 2, specifies an opening phase 10 with a first holding current 12 for fuel injector 2 and, in a second method step, a closing phase 11 beginning after opening phase 10, with a second holding current 13.

The second method step is a selective extension of a throttling phase of fuel injector 2 during the time period specified by instant tₐ 16 and a switch-off instant t_{c} 21. Injected fuel jet 25 is widened during the selective extension of the throttling phase of fuel injector 2, i.e., an individual jet cone angle 39 of conical individual fuel jet 25 is enlarged, while the overall jet-cone angle 40 remains virtually constant. This is illustrated in Figure V.

In a third method step, the current characteristic in solenoid coil 3 during closing phase 11 of fuel injector 2 is specified such that the magnetic field produced by second holding current 13 exerts a specific magnetic force, so that valve needle 6 thereby experiences a defined lift 14 that differs from zero, and retains it constantly for a defined time interval that is shorter than closing phase 11. Lift 14 produced by second holding current 13 is smaller than lift 14 produced by first holding current 12.

FIG. 2 shows a current-time diagram of the current as it is impressed upon solenoid coil 3 according to the example method of the present invention. In opening phase 10 of fuel injector 2 during time interval t_{b} 18, a premagnetizing current Iᵥₘ 19 in solenoid coil 3 is utilized for premagnetization. The current in solenoid coil 3 then rises to value Iₘₐₓ 44 until instant tₐₙ 20 after premagnetization current Iᵥₘ 19 has flown in solenoid coil 3. In addition, FIG. 2 shows the drop of the current flowing in solenoid coil 3 from Iₘₐₓ 44 to first holding current 13, which remains constant in time until the end of opening phase 10. The duration of first holding current 12 in opening phase 10 is specified by control device 9 as well. In a second method step, control device 9 specifies a current intensity of second holding current 13 that is lower than that of first holding current 12, and a switch-off instant t_{c} 21 within closing phase 11 of fuel injector 2.

FIG. 3 shows a lift-time diagram of the example method according to the present invention, a lift 14 of valve needle 6 of zero being specified within time interval t_{b} 18 in a third method step. At an instant t_{d} 22, which occurs later than tₐₙ 20, lift 14 of valve needle 6 has risen to a maximum lift 23, which remains constant in time until the end of opening phase 10. Following instant t_{ab} 24, lift 14 of valve needle 6 has dropped to less than one half of this maximum lift 23 and remains constant in time in closing phase 11 until switch-off instant t_{c} 21. Furthermore, at least three additional variants of a closing procedure 41, 42 and 43 having different rises are applicable to fuel injector 2.

FIG. 4 shows an idealized injection quantity-time diagram of the example method according to the present invention; according to the third method step, fuel injector 2 is dispensing an injection quantity of fuel both in opening phase 10 and in closing phase 11 that rises linearly over time until switch-off instant t_{c} 21 and is constantly zero in time following switch-off instant t_{c} 21 until the end of closing phase 11; in the case of small injection quantities, the injection quantity may possibly deviate from the linear relation as a function of the injection time, in particular during the opening and closing of fuel injector 2, this non-linear deviation being corrected in control device 9 by corresponding characteristic curves.

FIG. 5 shows a fuel-injection system 1 according to the present invention, which has a fuel injector 2 and a control device 9 for the selective injection of fuel.

Fuel injector 2 includes a solenoid coil 3, which is wound on a coil brace 26. Coil brace 26 is encapsulated in a valve housing 27.

Coil brace 26 is penetrated by a core 29, which is utilized as inner pole and has a tubular design. Valve housing 27, for example, may be used as outer pole of solenoid coil 3. Disposed downstream from inner pole 29 is an armature 5, which is integrally formed on a valve needle 6, for example.

Valve needle 6 is in operative connection, preferably by welding, with a valve-closure member 7, which has a conical shape in the exemplary embodiment and forms a sealing seat together with a valve-seat surface 32 of a valve-seat body 8.

Upstream from the sealing seat is a swirl disk 33. At least one spray-discharge orifice 34 is formed in valve-seat body 8, from which the fuel is injected into the combustion chamber (not shown further).

In the rest state of fuel injector 2, armature 5 is acted upon by a restoring spring 4 in such a way that fuel injector 2 is held closed by the contact pressure of valve-closure member 7 on valve-seat body 8. Restoring spring 4 is disposed in a recess of inner pole 29 and prestressed via a flange and by an adjustment sleeve 38. The fuel, conveyed via a central fuel supply 35, flows through fuel injector 2, through the recess of inner pole 29, and reaches the sealing seat and spray-discharge orifice 34.

If solenoid coil 3 is energized by an electric current via current cable 37 leading to control device 9, then a magnetic field builds up, which, given sufficient intensity, acts upon armature 5 counter to the force of restoring spring 4, counter to the direction of flow of the fuel. This closes a working gap 36 formed between armature 5 and inner pole 29. The movement of armature 5 also carries along in the lift direction valve needle 6 connected to armature 5, so that valve-closure member 7 lifts off from valve-seat body 8 and fuel is conveyed to spray-discharge orifice 34.

Fuel injector 2 is closed as soon as the current that energizes solenoid coil 3 is switched off and the magnetic field has decayed to the point where restoring spring 4 presses armature 5 away from inner pole 29, which causes valve needle 6 to move in the discharge direction and valve-closure member 7 to come to rest on valve-seat body 8.

A control device 9 is connected to fuel injector 2. Control device 9 and fuel injector 2 form fuel-injection system 1 according to the present invention for the injection of fuel into a combustion chamber (not shown further) of an internal combustion engine, fuel injector 2 experiencing a flow restriction during closing phase 11.

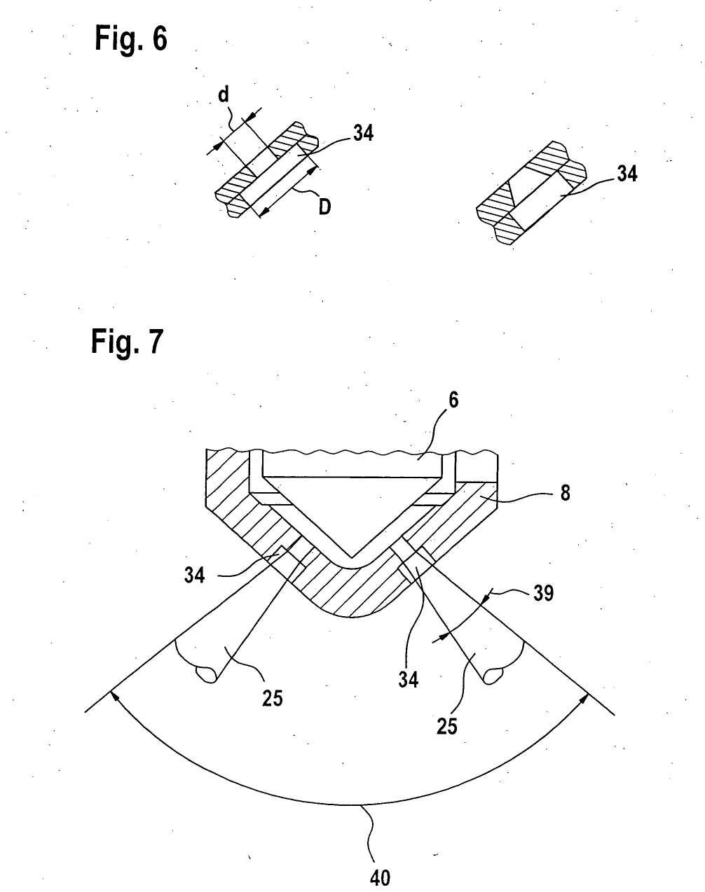

FIG. 6 shows a possible spray-orifice geometry that has great influence on the development of the jet-widening effect; a large ratio of step diameter D relative to spray-orifice diameter d is advantageous, and the spray orifice may have a conical characteristic.

FIG. 7 shows an enlarged view of the cutaway VII from FIG. 1.

This illustrates the difference between the individual jet cone angle and the overall jet cone angle.

The present invention is not limited to the exemplary embodiment shown. In particular, any combination of the individual features is possible.

1-13. (canceled)

14. A method for selective injection of fuel using a fuel-injection system, the fuel-injection system including a fuel injector having a solenoid coil, which cooperates with an armature acted upon by a restoring spring, the armature forming an axially displaceable valve component together with a valve needle, a valve-closure member provided on the valve needle, which forms a sealing seat together with a valve-seat body; and a control device coupled to the fuel injector and adapted to control the fuel injector, the method comprising:
specifying, by the control device, an opening phase with a first holding current for the fuel injector in a first method step; and
specifying, by the control device, a closing phase with a second holding current beginning after the opening phase in a second method step, wherein a current characteristic in the solenoid coil during the closing phase of the fuel injector is specified such that a magnetic field produced by the second holding current flowing inside the solenoid coil exerts a specific magnetic force, so that the valve needle thereby experiences a defined lift that differs from zero, and constantly retains it over a defined time interval, the lift produced by the second holding current being smaller than the lift produced by the first holding current.

15. The method as recited in claim 14, wherein the control device controls the opening phase and the closing phase of the fuel injector overall during a time interval, which results from an addition of a time interval for the opening phase and a time interval for the closing phase.

16. The method as recited in claim 14, wherein, in the first method step, the control device specifies a short time interval within the opening phase of the fuel injector during which a premagnetization current flows inside the solenoid coil.

17. The method as recited in claim 16, wherein, in the first method step, the control device specifies a rise in a current intensity in the solenoid coil to a maximum current at an instant after a premagnetization current has flown inside the solenoid coil.

18. The method as recited in claim 17, wherein, in the first method step, the control device specifies a drop of the current flowing inside the solenoid coil from the maximum current to the first holding current, which remains constant in time until an end of the opening phase.

19. The method as recited in claim 18, wherein, in the second method step, the control device specifies a current intensity of the second holding current that is lower than that of the first holding current, and a switch-off instant of the second holding current within the closing phase of the fuel injector.

20. The method as recited in claim 17, wherein, in a third method step, a lift of the valve needle of zero is specified until the switch-off instant.

21. The method as recited in claim 20, wherein, until an instant which occurs later than the instant after the premagnetization current has flown inside the solenoid coil, the lift of the valve needle rises to a maximum lift, which remains constant in time until the end of the opening phase.

22. The method as recited in claim 21, wherein the lift of the valve needle has dropped to less than one half of a maximum value by an instant and remains constant in time until a switch-off instant.

23. The method as recited in claim 16, wherein the second method step specifies a selective extension of a throttling phase of the fuel injector.

24. The method as recited in claim 23, wherein an injected fuel jet is widened during the selective extension of the throttling phase of the fuel injector.

25. A fuel-injection system for an injection of fuel, comprising:
a fuel injector including a solenoid coil, which cooperates with an armature acted upon by a restoring spring, the armature forming an axially displaceable valve component together with a valve needle, a valve-closure member being provided on the valve needle, which forms a sealing seat together with a valve-closure body; and
a control device connected to the fuel injector and adapted to control the fuel injector, the control device specifying an opening phase with a first holding current for the fuel injector and a closing phase with a second holding current beginning after the opening phase, the control device adapted to specify a current characteristic in the solenoid coil during the closing phase of the fuel injector such that a magnetic field produced by the second holding current flowing inside the solenoid coil exerts a specific magnetic force, so that the valve needle thereby experiences a defined lift that differs from zero and constantly retains it over a defined time interval, the lift produced by the second holding current being smaller than the lift produced by the first holding current.

26. The fuel-injection system as recited in claim 25, wherein the second holding current amounts to less than one half of the first holding current.
